(19) United States
(12) Patent Application Publication
(10) Pub. No.: US 2019/0050946 A1
(43) Pub. Date: Feb. 14, 2019

(54) AUTOMATED ACTIVITY TRACKING SYSTEM

(71) Applicant: Data Harvest Inc., West Chester, PA (US)

(72) Inventor: Peter M. Hicks, West Chester, PA (US)

(73) Assignee: Data Harvest Inc., West Chester, PA (US)

(21) Appl. No.: 15/671,596

(22) Filed: Aug. 8, 2017

(51) Int. Cl. G06Q 50/02; G06Q 10/06; H04W 4/02

(52) U.S. Cl. CPC G06Q 50/02; H04W 4/021; G06Q 10/063114

(57) ABSTRACT

Beacons that transmit identification signals are located on equipment that workers may utilize during the course of their jobs. A server may define parameters about the equipment the beacons are located on and geo-fences around areas of interest. A worker carriers a wireless device that is capable of receiving the beacon signals and determining location of the worker. The wireless device has an activity tracking app running thereon that can communicate with the server. A determination is made as to the equipment assigned to the worker based on the beacon signals received by the worker and if the worker is within an area of interest based on their location. Activities can be initiated for the worker based on the defined area and the equipment (e.g., if worker is assigned a tractor and a mower and is within field 1, the activity the worker is assigned is mowing field 1).

### BACKGROUND

Farming and related endeavors currently have a number of commercially available options for tracking tractor location and crop locations. Many of these devices are expensive and limited in the extent to which they can track the day of a worker such as a farm worker. Often these devices cost tens of thousands of dollars and are installed in machinery such as a tractor. Inherently, a device that is installed within a vehicle is designed to track the operation of that vehicle and does not track or follow a worker or operator who may perform multiple tasks throughout a single day. The installed device cannot follow a worker after leaving the vehicle.

What is needed is a simpler and more cost effective solution that can track the activities of a particular worker throughout a given time period, such as a day, and track the activities of that worker as well as calculate the time spent on activities. Furthermore, an automated method is needed for tracking the activities that limits the amount of user input that is required, and avoids errors resulting from missing data or incorrect entries.

### SUMMARY

Beacons are located on equipment that workers may utilize during the course of their jobs. The beacons transmit signals that include an identification. The signals are transmitted over a short distance (e.g., Bluetooth). The beacon identification and parameters about the equipment they are located on are defined in a server. A worker carriers a wireless device (e.g., smart phone, tablet) that is capable of receiving the beacon signals. The wireless device has an activity tracking app running thereon that can communicate with the server. A determination is made as to the equipment assigned to the worker based on the beacon signals received by the worker.

The server may also have geo-fences defined around areas of interest. The wireless device may include a GPS module that can determine the location of the worker. The communications with the server can determine when the worker enters one of the defined areas of interest (e.g., crosses the geo-fence). Based on the location of the worker within a defined area and the equipment assigned to the worker, activities can be initiated for the worker. For example, if the worker is assigned a tractor and a mower based on the beacon signals he received and the GPS module determines that he is within a boundary (geo-fence) for field 1, the system may determine that the activity the worker is performing is mowing field 1. The system may communicate with the worker to confirm the activity (e.g., present questions on the wireless device).

The system may track the location of the worker at defined intervals (e.g., every 10 minutes) to provide tracking of the worker during the course of a day. The system may utilize the activity tracking for automatic generation of task sheets and/or time sheets. The system may analyze the various data collected to produce metrics and reports. A system administrator may send specific work assignments directly to the workers wireless device. The worker may utilize their wireless device to document different information and/or take pictures.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 illustrates an example high level system diagram for the use of a beacon, according to one embodiment;

FIG. 2 illustrates an example high level functional diagram of a generic mobile device that can be utilized to detect signals broadcast by the beacon and connect to an appropriate server, according to one embodiment;

FIG. 3 illustrates an example use of beacons on farm equipment for tracking tasks of farmers, according to one embodiment;

FIG. 4 illustrates an example high level functional diagram of a server that can be utilized to manage beacons that are located on equipment and the activities that are associated with the equipment being utilized by a worker and possibly the location of the user, according to one embodiment;

FIG. 5 illustrates an example diagram of information stored in a database utilized in an activity tracking system, according to one embodiment;

FIG. 6 illustrates a flow diagram of an example method for establishing operation of an activity tracking system for a business entity, according to on embodiment;

FIG. 7 illustrates an example use of beacons on equipment and geo-fences around areas of interest, according to on embodiment; and

FIG. 8 illustrates a flow diagram of an example method for utilizing an activity tracking app and an activity tracking system, according to one embodiment.

### DETAILED DESCRIPTION

Reference will now be made in detail to presently preferred embodiments, examples of which are illustrated in the accompanying drawings, wherein like reference numerals refer to like elements throughout.

Beacons are devices that transmit (e.g., broadcast) wireless signals that include, for example, an identification for the beacon. The wireless signals are short distance wireless signals, such as Bluetooth or Wi-Fi signals. The beacons may be associated with a server and the server may have parameters about the beacon defined therein. A wireless device (e.g., smart phone, tablet, smart watch) that is in relatively close proximity to the beacon may be capable of detecting the wireless signals. The wireless device may have a software app running thereon that receives the signals and communicates with a server associated with the software app. If the beacon is associated with the app/server, then appropriate action may be taken based thereon.

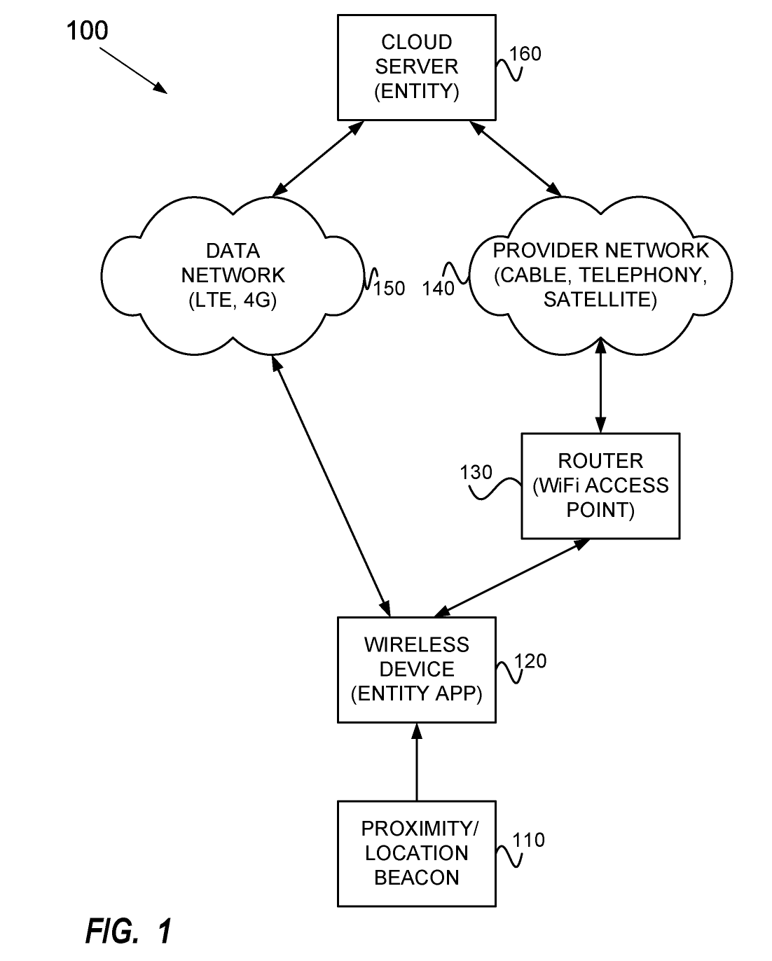

FIG. 1 illustrates an example high level system diagram 100 for the use of a beacon. A beacon 110 is located, for example, on a piece of equipment and transmits a signal that provides information (e.g., identification) about the beacon 110. According to one embodiment, the beacon 110 may transmit in Bluetooth. A wireless device 120 is capable of receiving the signal from the beacon 110. The wireless device 120 may include a software app that can use the signal from the beacon 110. The software app may be associated with a specific entity, for example, business, store, or location. The software app may utilize the wireless device 120 to communicate with a server 160 (e.g., a cloud server) associated with the entity.

The wireless device 120 may communicate with the server 160 by connecting to a router 130 via, for example, a Wi-Fi connection. The router 130 provides an access point to a provider network 140 (e.g., a cable network, a telephony network, a satellite network). The provider network 140 provides access to the Internet, including the server 160. If a Wi-Fi connection is not available, the wireless device 120 may communicate with the server 160 via a data network 150 provided by the service provider for the wireless device 120. The data network 150 may be, for example, LTE, 3G or 4G.

The app running on the wireless device 120 may access the server 160 to verify that the beacon is associated therewith, determine equipment that the beacon is located on, and determine actions to be taken based thereon. In addition to the beacon identification, the server 160 may receive additional information from the app (e.g., location, wireless device identification). The server 160 may store the data received from the software apps. According to one embodiment, the data may be capable of being sorted by wireless device or user.

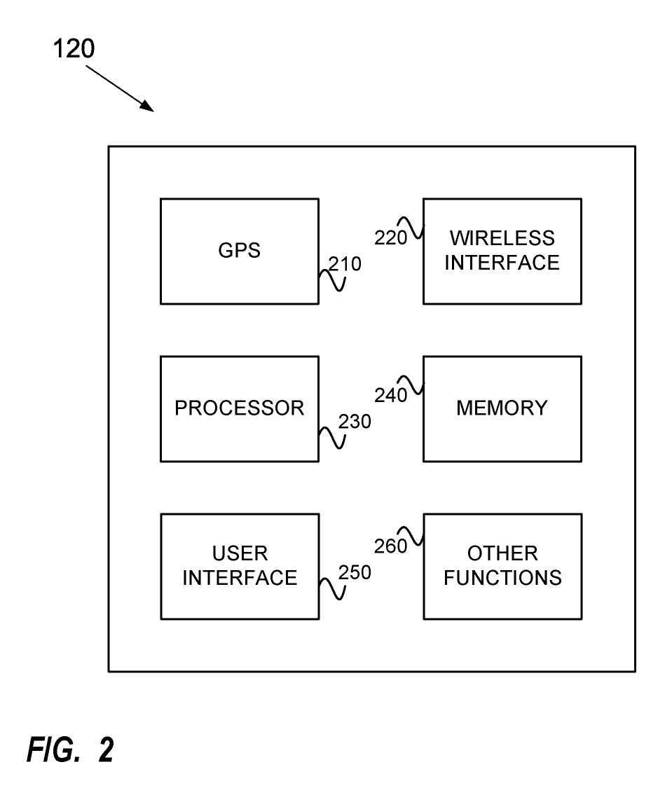

FIG. 2 illustrates an example high level functional diagram of a generic mobile device 120 that can be utilized to detect signals broadcast by the beacon 110 and connect to an appropriate server 160. The mobile device 120 may include a GPS module 210, a wireless interface 220, a processor 230, memory 240, a user interface (UI) 250 and other functions 260 related to the operation of the specific mobile device 120. The GPS module 210 is to determine the location of the mobile device 120. The wireless interface 220 is to, for example, detect signals being broadcast by the beacon 110 (e.g., Bluetooth), connect to other wireless devices (e.g., Wi-Fi, Bluetooth) and wireless (e.g., Wi-Fi) network access points (routers) 130, and/or connect to the data network 150. The wireless interface 220 provides the communication link to, amongst other things, the beacon 110 and the server 160. The wireless interface 220 may be multiple different interfaces including, for example, Wi-Fi, Bluetooth, LTE, 3G, 4G and/or near field communications (NFC).

The processor 230 is to control the operation of the mobile device 120 and execute computer-executable instructions (e.g., software, apps). The memory 240 is to store the computer-executable instructions and/or other data. The memory 240 may be located on the processor 230 and/or may be separate from the processor 230. The memory 240 storing the computer-executable instructions may be computer-readable memory so that the processor 230 can read and execute the computer-executable instructions. According to one embodiment, an entity app may be stored in the memory 240 and executed by the processor 230. When the entity app is executed by the processor 230 the app may receive the beacon identification signals, access the server 160 (e.g., to receive information from and store data to), present information to and receive information from a user via the UI 250, and take other appropriate actions (where the actions may be defined in the server 160 based on beacons 110 identified).

The UI 250 is to provide information to the subscriber and enable the subscriber to interact with the device 120. As one skilled in the art would recognize, the types of UIs 250 may vary greatly based on the device 120. For example, the UI 250 may be a display, a touch screen display, buttons, keypad, speakers, and/or microphone (e.g., for voice interaction). The other functions 260 may vary based on the device 120. For example, if the device 120 was a mobile phone the other functions 260 may include a cell phone module. If the device 120 was an activity tracker the other functions 260 may include a heart rate monitor, sleep monitor and/or pedometer. If the device 120 was a computer or tablet capable of displaying audiovisual content the other functions 260 may include an audio/video decoder.

The beacons 110 can be utilized to determine when a user in in proximity to one or more objects. For example, beacons 110 may be located on various pieces of equipment (e.g., farm equipment) that may be used by workers (e.g., farmers). The workers may carry a wireless device 120 (e.g., smart phone, tablet, smart watch) that includes an entity app running thereon. The beacons 110 may broadcast a wireless signal (e.g., Bluetooth) that includes an identification for the beacon. The wireless device 120 may receive the signal and the entity app running thereon may access the server 160 to determine if the beacon is associated therewith. The server 160 may define the beacons 110 as being associated with the piece of equipment they are located on (e.g., tractor, plow, seeder, baler).

Based on the equipment that is detected in close proximity to the worker, the server 160 may make a determination as to what task the worker may be doing. The wireless device 120 may be equipped with GPS functionality to determine a location of the worker. The location of the worker may be utilized in the determination of an activity (e.g., task at specific location) being performed. A work order may be presented to the worker based on the activity determination.

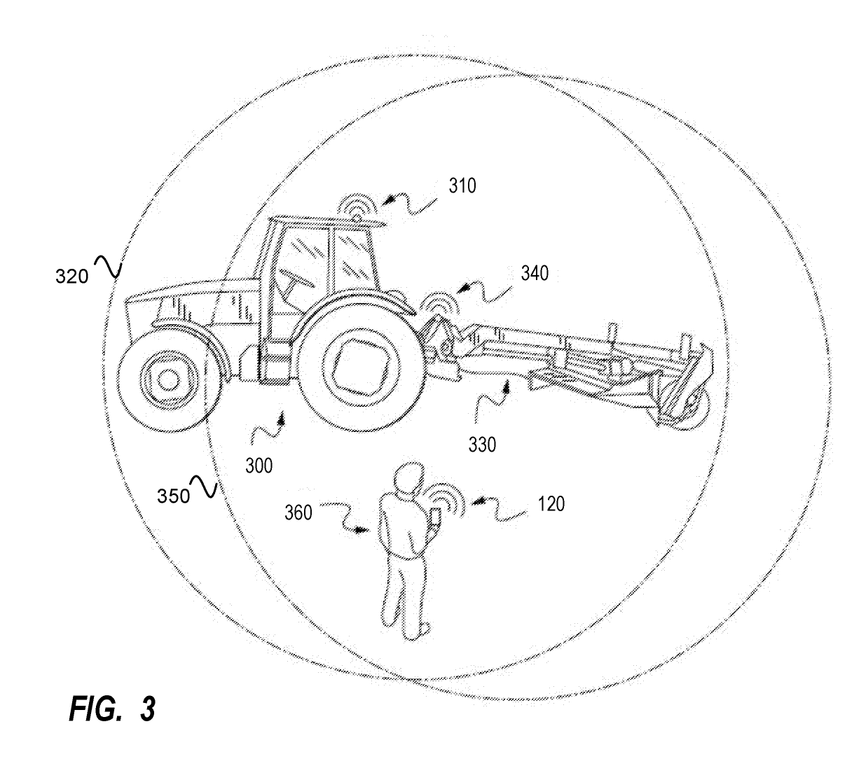

FIG. 3 illustrates an example use of beacons on equipment (e.g., farm equipment) for tracking tasks of workers (e.g., farmers). The basic types of farm equipment that the beacons may be located on include, for example, transport vehicles and implementation machines. Transport vehicles are equipment that is capable of moving from one location to another on their own and may transport additional equipment (e.g., mowers, balers, seeders, plows) as well. The transport vehicles may include, for example, tractors and trucks. The implementation machines are equipment that is capable of performing a task (e.g., mowing, baling, seeding, plowing) but is not capable of transporting itself. Rather, the implementation machine may be transported by a transport vehicle. The implementation machines may include, for example, mowers, balers, plows and seeders.

A tractor 300 (transport vehicle) has a beacon 310 located on a cab thereof and a range of a signal transmitted thereby is indicated by radius 320. A mower 330 (implementation machine) has a beacon 340 located on a hitch thereof and a range of a signal transmitted thereby is indicated by radius 350. As illustrated, the range 320, 350 of the beacons 310, 340 is approximately the same but is not limited thereto.

A worker 360 has a wireless device 120 (e.g., smart phone, tablet, smart watch) that is used during the course of a work day. The wireless device 120 includes a software app related to tracking activities performed by the worker running thereon (activity tracking app). When in close proximity (within the ranges 320, 350) to the beacons 310, 340, the wireless device 120 may receive the signals from the beacons 310, 340. The location and signal strength of the beacons 310, 340 may be selected so that the signal can be detected by the wireless device 120 of the worker 360 that would be utilizing the equipment and where the worker 360 would be located with respect to the equipment. As one skilled in the art would understand, the further the beacon 310, 340 is from the worker 360 and their wireless device 120, the stronger the signal strength required. As such, the signal strength of the beacon 340 may be stronger than the signal strength of the beacon 310 as the worker 360 is likely further away from the mower 330 when the worker 360 is in the cab of the tractor 300 and the mower 330 is being pulled behind the tractor 300.

The activity tracking app may utilize the signals (e.g., identification) received from the beacons 310, 340 to determine the equipment that is in close proximity to the worker 360 (e.g., look up parameters related to the beacon identification). The activity tracking app may do this by communicating with a server 160 associated with the app. The wireless device 120 may communicate with the server 160 using Wi-Fi, if a Wi-Fi access point 130 is available, or using a data network 150 (e.g., LTE, 3G, 4G).

The activity tracking app may further communicate with the server 160 to determine the type of task that may be performed by the worker based on the equipment (alone or in combinations) they are in close proximity to. For example, if the worker is in close proximity to the tractor 300 and the mower 330 the determination may be that the worker may be capable of performing the task of mowing (the worker has the equipment required for mowing). It should be noted that the actual performance of the task mowing may not start until the worker gets to, for example, a field where there is a crop to be mowed. The actual performance of the task may be defined as an activity and the performance of the activity may be tracked. A work order may be presented to the worker based on the activity determination.

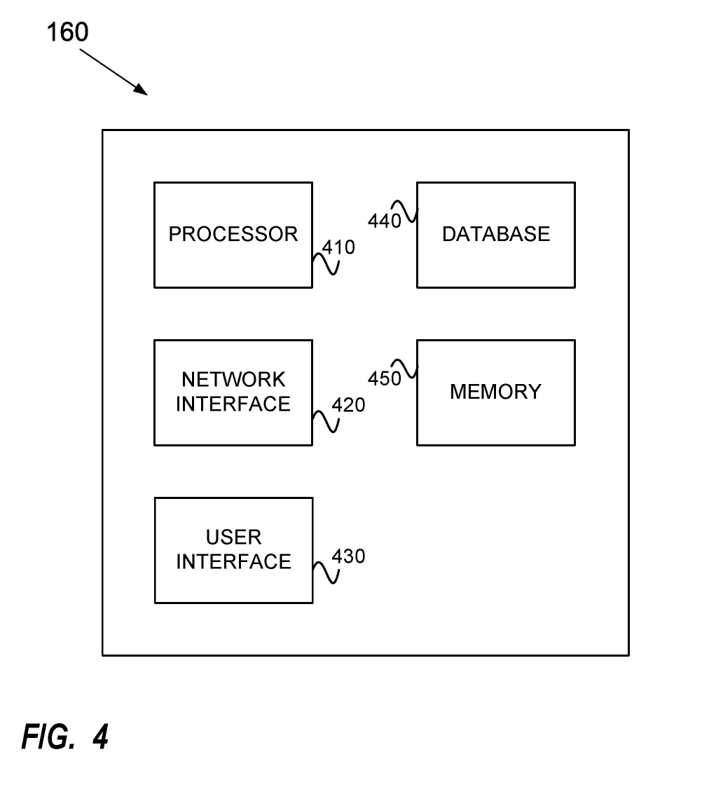

FIG. 4 illustrates an example high level functional diagram of a server 160 that can be utilized to, for example, manage beacons that are located on equipment, tasks associated with the equipment, and activities being performed by the workers in defined areas (activity tracking system). The server 160 may include a processor 410, a network interface 420, a user interface (UI) 430, a database 440 and memory 450. The processor 410 is to control the operation of the server 160 and execute computer executable instructions. The instructions that are executed include the activity tracking system instructions that perform at least the following tasks: manage beacons (e.g., associate them with equipment), associate defined areas with geo-fences, associate tasks with equipment, associate activities with tasks and defined areas, and determine a worker is performing an activity when they are within the defined area with the appropriate equipment.

The network interface 420 is to provide for communications with users, including for example, administrators and users (e.g., via their wireless devices 120) of the activity tracking system operating on the server 160. The network interface 420 provides the link to the Internet or other networks (e.g., data network 150, provider network 140). The UI 430 is to enable interaction with the server 160 and can be provided by any combination of various items (e.g., keyboards, displays, trackpads) as would be known to those skilled in the art. It should be noted that the server 160 is likely to be in the cloud so that the UI 430 may be provided via a web portal (e.g., an administrative dash board) for administrators and via an app running on their wireless device 120 for users (workers).

The database 440 is where information pertaining to the activity tracking system is maintained. The database 440 may include information that is necessary for the system to operate that may be populated by a system administrator (e.g., via an administrative dashboard). The database 440 may include a list of beacons and the equipment associated with each beacon and any specific parameters (e.g., configurations) associated the equipment. The database 440 may include a list of certain areas of interest (e.g., fields, lots, barns, stores, garages, warehouses, vendors, customers), a description of the areas and geo-fences defining the perimeter of the areas.

The database 440 may include a list of tasks (e.g., plowing, mowing) that are associated with different combinations of equipment and a list of activities (e.g., plowing field 4) associated the combination of tasks and defined area of interest. It should be noted that rather than associate equipment with tasks, and tasks and defined areas with activities, that tasks may be excluded and equipment and defined areas may simply be associated with activities. The database 440 may include questions that should be presented to the worker for the different tasks and/or activities (e.g., what type of seed are you using, how high is the crop, what crop are you dropping at the warehouse, what work are you getting done at the vendor).

The database 440 may include information that is gathered during the operation of the activity tracking system. The information may be provided by the apps running on the wireless devices 120 that communicate with the server 160. The information stored in the database 440 may include, for example, the beacons detected, the time and location for the beacon detection, entry/exit from the area defined by geo-fences and times associated therewith, the activities associated with the workers and the times associated with the activities, and location of the worker at defined intervals (e.g., every 5 minutes).

The parameters (e.g., number, type, configuration) of the database 440 may vary based on implementation. One skilled in the art would understand the various ways to establish the database(s) 440 and select an appropriate set up.

The memory 450 is to store the computer-executable instructions and possibly other data (including the database 440). The memory 450 may be located on the processor 410 and/or may be separate from the processor 410. The memory 450 storing the computer-executable instructions may be computer-readable memory so that the processor 410 can read and execute the computer-executable instructions. According to one embodiment, instructions for an activity tracking system may be stored in the memory 450 and executed by the processor 410. When the activity tracking system is executed by the processor 410 the activity tracking system may enable a system administrator to, for example, associate (a) beacons to equipment; (b) geo-fences to boundaries of the areas of interest (e.g., fields, lots, vendors, customers); (c) equipment to tasks; and (d) tasks and areas of interest to activities. It should be noted that (c) the association of equipment to tasks may be excluded and that (d) the association of activities may be based on areas of interest and equipment.

When the activity tracking system is executed by the processor 410 the activity tracking system may enable wireless devices 120 to access the server 160 to, for example, determine (a) equipment assigned to a worker based on beacons detected; (b) worker being within areas of interest; and (c) the tasks and the activities a worker is performing, and may record appropriate information in the database 440. It should be noted that the determination of tasks may be excluded.

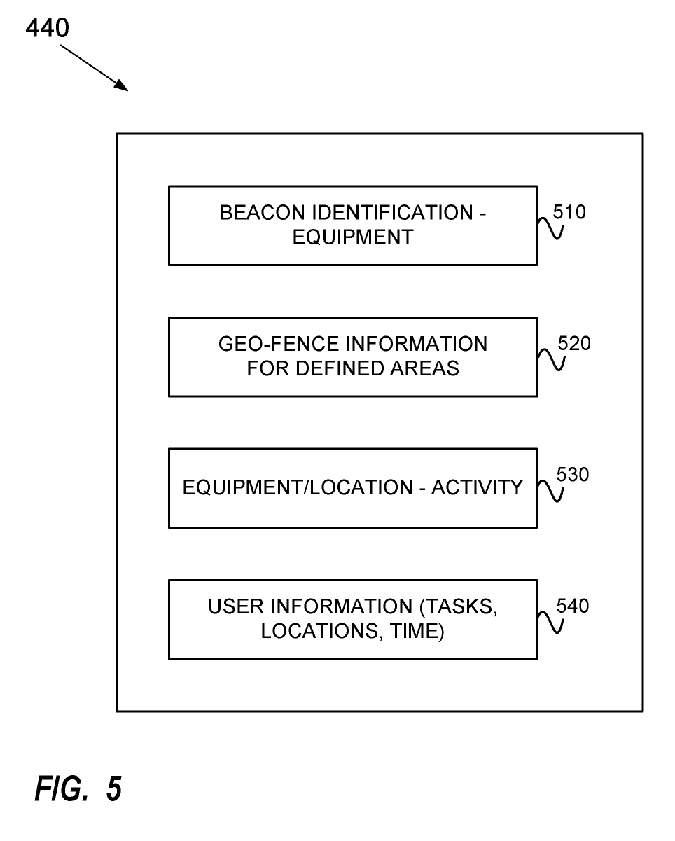

FIG. 5 illustrates an example diagram of information stored in a database 440 utilized in an activity tracking system. The database 440 may include beacon identification information 510, defined area information 520, task/activity information 530 and user (worker) information 540. The beacon identification information 510 may include, for example, the identification for each of the beacons that are defined for the system and information about the equipment that the beacon is associated therewith. The information may simply be the type of equipment or may be the type of equipment and parameters associated therewith. For example, beacon 1234 may be associated with a specific tractor (tractor 7) and the tractor may be capable of pulling a plow, mower and baler but not a seeder.

The defined area information 520 may include, for example, an identification of each of the areas of interest (e.g., fields, lots, vendors, customers) and parameters about each of them. The parameters may include specifics (e.g., what type of field, crops planted there, name of vendor/customer and goods/services provided by/to) as well as defining a geo-fence for the area. The geo-fence is an identification of the boundaries of the area on a mapping application, such as, Google ® Maps. The geo-fence can be used to determine when a worker is within the boundaries of the area (e.g., when they enter and exit the area).

The task/activity information 530 may include, for example, tasks that are associated with different combinations of equipment. For example, a tractor alone may be associated with any number of tasks, including, for example, relocation, maintenance, and preparing for tasking. When the tractor is paired with, for example, an implementation machine it may have specific tasking associated therewith. For example, a tractor and a plow together may be associated with plowing, a tractor along and a mower may be associated with mowing, a tractor and a baler may be associated with baling and a tractor and a seeder may be associated with seeding.

The task/activity information 530 may include, for example, activities that are associated with different combinations of tasks and specific areas of interest. For example, the mowing task in defined area field 1 may be associated with mowing field 1. The various activities may also include specific questions that may be presented to the worker upon a determination that the activity is being performed. For example, if the activity is seeding field 1, the question may pertain to the type of seed being used or the amount of seed. If the activity is mowing field 2, the question may pertain to the height of the crop prior to mowing.

The user (worker) information 540 may include data about the worker as well as data collected by the wireless device 120. The worker data may include, for example, name, employee identification, job title, pay grade, normal hours worked, authorized areas of interest and wireless device identification. The data collected may include the beacon identifications detected by the worker's wireless device 120, along with, for example, the time and location the beacons were detected and the time and location when the beacons were out of contact. The data collected may also include tasks associated with the worker, areas of interest that the worker enters and the times the worker enters and exits, and activities associated with the worker and the times associated therewith. The data collected may also include questions that were answered by the worker (e.g., type of seed used).

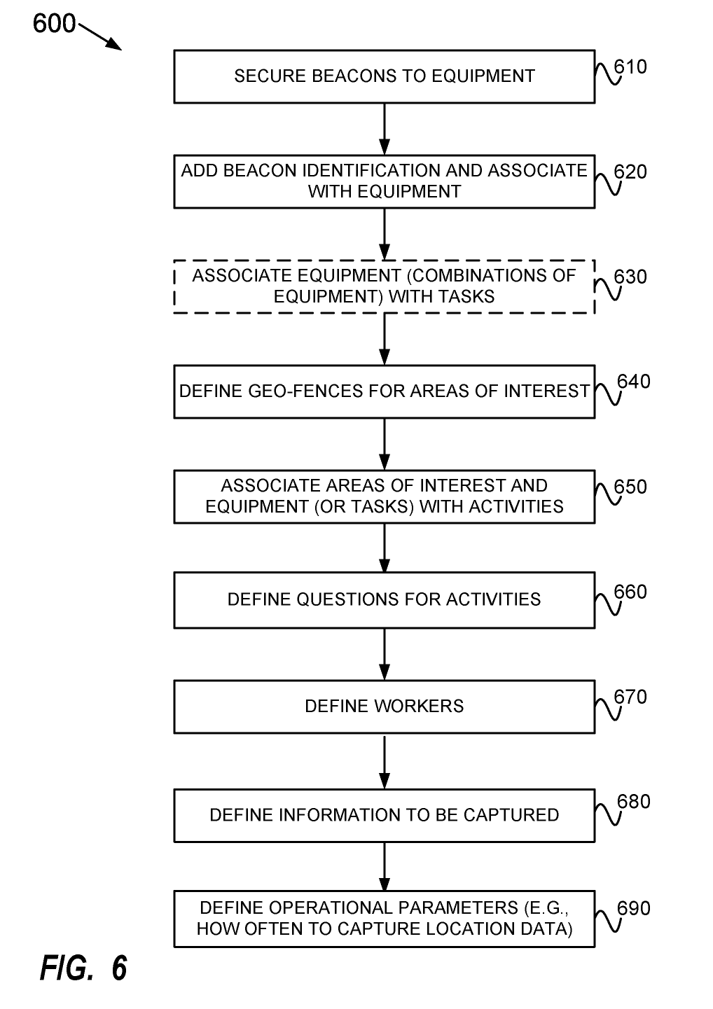

FIG. 6 illustrates a flow diagram of an example method 600 for establishing operation of an activity tracking system for a business entity (e.g., farm owner). Beacons are obtained and secured to equipment (e.g., tractors, mowers) that may be utilized by workers (e.g., farmers) in the course of them performing their activities (e.g., mowing fields) 610. The beacon is then defined in the activity tracking system 620. This may include recording the beacon identification and identifying the equipment that the beacon is associated with. The equipment, alone and/or in different combinations, may optionally be associated with different tasks 630. For example, the combination of a tractor and a plow may be associated with a plowing task. Defined areas of interest (e.g., fields) may have geo-fences defined for the boundaries thereof 640. The geo-fences may be defined using, for example, Google® Maps.

Different combinations of areas of interest and equipment (or optionally tasks previously determined based on equipment) may be associated with activities 650. For example, the combination of the worker having a tractor and plow (or determination of a plowing task) and field 1 as the area of interest may be associated with an activity of plowing field 1. Questions that may be asked of the worker when an activity is determined may be defined 660. The questions may include, for example, what seed are you using for an activity of seeding field 4? The workers may also be defined in the system 670. The workers may be defined by, for example, employee name, employee identification, type of worker, and wireless device identification.

The system may define that type of information that is to be captured and/or collected 680. At least some of the information that is to be captured may be captured from the workers wireless device 120. The information to be captured may include, for example, beacon identification for beacons detected, time in/time out for work day/activities, location, answers to questions presented by the system for activities, and other information (e.g., photos of crops, receipts for gas/repairs). The operational parameters of the system may be defined 690. For example, how often location data should be captured, how long of a delay between detecting a beacon signal (or losing a beacon signal) and associating the user with the equipment (or disassociating from the equipment) and how long after the worker crosses the boundary is a determination made that the worker is within the defined area (or has left the defined area).

Most (e.g., 620-690) of the steps (processes) of the method 600 may be performed by, for example, a system administrator using, for example, an administrative dashboard of the activity tracking system. Computer-executable instructions stored on a computer-readable storage medium (e.g., memory 450) when executed by the processor 410 may cause the processor 410 to provide the administrative dashboard, allow the appropriate steps of the method 600 to be performed and take the appropriate actions based thereon (e.g., configure the system).

The method 600 is in no way intended to be limited to the illustrated steps. Rather, additional steps can be added, steps can be combined, steps can be deleted, steps can be modified and/or the order of the steps can be modified without departing from the current scope. For example, if the optional association of tasks to equipment 630 is excluded then the association of activities is based on areas of interest and equipment 650 while if the association of tasks to equipment 630 is included then the association of activities is based on areas of interest and tasks 650.

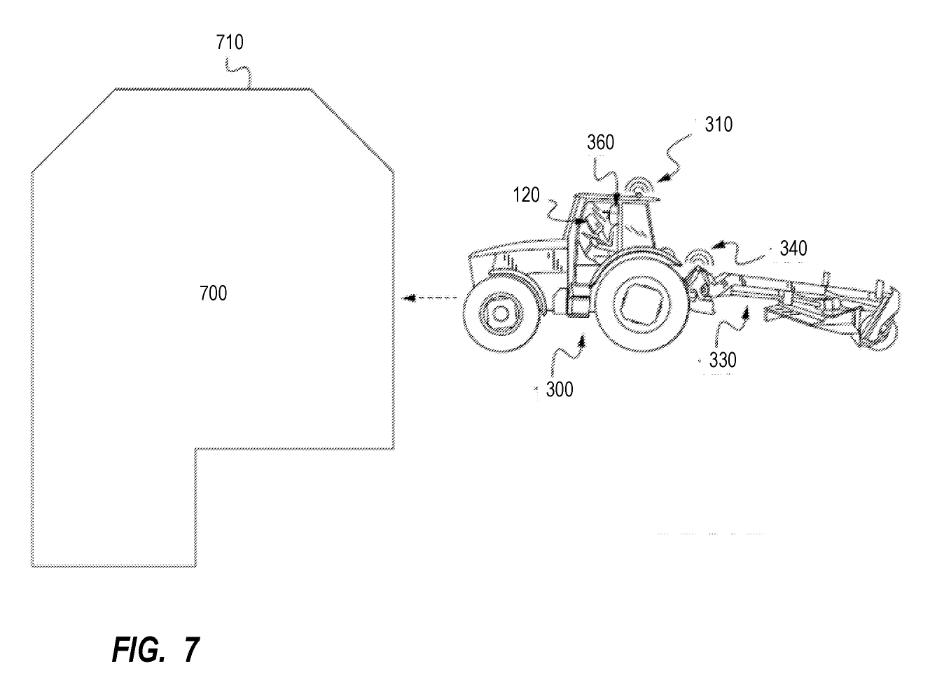

FIG. 7 illustrates an example use of beacons on equipment and geo-fences around areas of interest (fields). The worker 360 is riding the tractor 300 having the beacon 310 located on the cab thereof and is pulling the mower 330 that has the beacon 340 located on the hitch thereof. The worker 360 has their wireless device 120 with them and the wireless device 120 includes the activity tracking app loaded and running thereon. The activity tracking app running on the workers wireless device 120 detects the signal (e.g., beacon identification) from each of the beacons 310, 340. According to one embodiment, after the signals from the beacons 310, 340 are detected the activity tracking app may communicate with the worker 360. The communications with the worker 360 may occur as soon as the beacon signals are detected or after the signals have been detected for a predefined amount of time (e.g., 5 seconds). The communications may be, for example, presenting audio and/or visual messages to the wireless device 120. The communications may include, for example, asking the worker 360 whether they are working and reminding the worker 360 to clock in if they are working and are not already clocked in.

The activity tracking app may communicate with the server 160 to determine that the beacons 310, 340 are associated with the tractor 300 and the mower 330 respectively based on the beacon identifications. The worker 360 can then be assigned the tractor 300 and the mower 330 and may optionally be associated with the task of mowing. As noted above, since task association at this point is simply identifying tasks that may be performed based on the equipment available this association may be excluded. Rather, the equipment in addition to a defined area may be utilized to associate an activity (the actual performing of a task). The assignment of the equipment 300, 330 to the worker 360 and the optional determination of task may be recorded in the database 440. Information recorded may include, for example, equipment, worker, time, location, and possibly task.

The association of the beacon signals to the equipment 300, 330 and/or the assignment of the equipment 300, 330 to the worker 360, may be made as soon as the beacon signals are detected. Alternatively, the association/assignment may be made after the signals have been be available to the wireless device 120 for a predefined amount of time (e.g., 5 seconds). The delay in the association/assignment may prevent premature assignments of equipment to the worker 360. That is, the delay may ensure that the worker 360 is using the equipment 300, 330 and didn't just come in close proximity to equipment they will not be using. According to one embodiment, after the association/assignment of equipment 300, 330 to the worker 360, the activity tracking app may communicate with the worker 360. The communications may include, for example, reminding the worker 360 to clock in if they have not yet and/or asking the worker 360 to confirm the assignment of the equipment 300, 330 (e.g., are you using tractor 1 and mower 3?).

If the determination of the task based on the equipment 300, 330 that the worker 360 has at their disposal is utilized, then the determination may be made as soon as the equipment 300, 330 is assigned to the worker 360. Alternatively, the determination may be made after the some predefined amount of time (e.g., 3 seconds) from the equipment assignment. The delay may prevent premature determinations. According to one embodiment, after the determination of task, the activity tracking app may communicate with the worker 360. The communications may include, for example, asking the worker 360 whether they want to be automatically clocked if they are not already clocked in and/or asking the worker 360 to confirm the task (e.g., are you going to be mowing?).

As illustrated, the worker 360 is on their way to an area of interest 700 having boundaries (perimeter) 710 that may be defined by a geo-fence or other digital representation. The area of interest 700 may be, for example, a field that contains a particular crop, a work site that contains a particular resource such as timber or ore, or a barren field that will be planted with seed to produce a crop. As the worker is utilizing a tractor 300 and a mower 330 it is likely that the area of interest 700 will be a field that needs to be mowed (e.g., hay field).

The wireless device 120 may include a GPS module 210 that is used to determine the location (e.g., latitude and longitude) of the worker 360 (and associated equipment 300, 330). When the worker 360 is on their way to the area of interest 700 the activity tracking app may communicate with the server 160 and a transportation activity may be initiated. The transportation activity may be initiated, for example, once the equipment starts to be moved, after the equipment has moved a certain distance, or after the equipment has been moving for a defined amount of time. According to one embodiment, after the initiation of the transportation activity, the activity tracking app may communicate with the worker 360. The communications may include, for example, asking the worker 360 to confirm the transportation activity (e.g., are you transporting the equipment 300, 330?) and/or asking the worker 360 questions about the transportation activity (e.g., where are you transporting the equipment 300, 330 to?).

The transportation activity may be recorded in the database 440. Information recorded may include, for example, worker, equipment, location, time when the transportation activity is initiated and a time when the transportation activity is stopped (e.g., completed, new activity begins). The start and stop time may be used to track amount of time that the transportation activity took.

The activity tracking app may utilize the location of the worker 360 when it communicates with the server 160 to determine when the worker 360 is within the area 700 by determining when the worker 360 has crossed over the boundary 710. The determination may be based on comparing the GPS coordinates of the wireless device 120 to the coordinates associated with the boundary 710 (e.g., the geo-fence). Once a determination is made that the worker 360 is within the defined area 700 a specific activity related to the equipment, or the defined task (e.g., mowing), and the defined area of interest (e.g., field 1) may be initiated.

The initiation of the activity (e.g., mowing field 1) may be done as soon as the worker 360 (and equipment 300, 330) crosses the boundary 710. Alternatively, the initiation may be done after the some predefined amount of time (e.g., 3 seconds). The delay may prevent premature initiations. According to one embodiment, after the initiation of the activity, the activity tracking app may communicate with the worker 360. The communications may include, for example, asking the worker 360 to confirm the initiation of the activity (e.g., are you mowing field 1?), asking the worker 360 questions about the area 700 (e.g., how tall is the crop?, what are the soil conditions?, what is the height setting of the mower?) and/or requesting the worker 360 to document conditions related to the area 700 (e.g., take pictures of the field). The initiation of the activity (e.g., mowing field 1) may be recorded in the database 440. Information recorded may include, for example, worker, equipment, location, time activity is initiated, answers to questions, and images captured.

The activity tracking app and the server 160 may utilize the location of the worker 360 to determine when the worker 360 exits the area 700 by detecting when the worker 360 crosses the boundary 710. Alternatively, a buffer zone (not illustrated) may be defined around the area 700 and the worker 360 will only be determined to have exited the area 700 if they cross the buffer zone. The buffer zone may extend a certain distance (e.g., several feet) past the border 710. The buffer may enable the worker 360 to exit the boundary 710 to turn around at the end of a row. Once the determination is made, the specific activity that was initiated and was being tracked (e.g., mowing field 1) may be terminated (e.g., considered complete).

The termination of the activity (e.g., mowing field 1) may be done as soon as the worker 360 (and equipment 300, 330) crosses the boundary 710. Alternatively, the termination may be done after the some predefined amount of time (e.g., 2 minutes). The delay may prevent premature terminations that could be determined, for example, when the worker 360 exits the boundary 710 to turn around at the end of a row. According to one embodiment, after the termination of the activity, the activity tracking app may communicate with the worker 360. The communications may include, for example, asking the worker 360 to confirm the termination of the activity (e.g., are you done mowing field 1), asking the worker 360 questions about the area 700 or activity (e.g., what height was the hay cut to?, how much hay needs to be baled?, how much seed was used?) and/or requesting the worker 360 to document conditions related to the area 700 (e.g., take pictures of the field). The termination of the activity (e.g., mowing field 1) may be recorded in the database 440. Information recorded may include, for example, worker, equipment, location, time when the activity is initiated, answers to questions, and images captured.

If the activity tracking app determines that the worker 360 (and equipment 300, 330) is not moving after a specific activity (e.g., mowing field 1) was initiated and is being tracked, a determination may be made that the activity has been paused. The pause of the activity (e.g., mowing field 1) may be initiated after the worker 360 has not moved for some predefined amount of time (e.g., 5 minutes). According to one embodiment, after the pause of the activity, the activity tracking app may communicate with the worker 360. The communications may include, for example, asking the worker 360 to confirm the pause of the activity (e.g., are you taking a break from mowing field 1) and/or asking the worker 360 to identify reason for the pause (e.g., work break, refueling, equipment repair, checking area 700). The pause of the activity (e.g., mowing field 1) may be recorded in the database 440. Information recorded may include, for example, worker, equipment, location, time when the activity is paused, answers to questions, and images captured.

The activity tracking app may determine that the wireless device 120 of the worker 360 is no longer receiving signals from one or more of the beacons. A determination may be made that the worker 360 is no longer using the equipment 300 and/or 330 (equipment is delinked from worker). If the delinking occurs while the worker is still in the area (e.g., field 1) 700 performing a specific activity (e.g., mowing field 1), a determination may accordingly be made that the activity is no longer being performed. The determination that the equipment 300 and/or 330 is no longer being used by the worker 360 may be made after the activity tracking app has not received the beacon signals for some predefined amount of time (e.g., 2 minutes). The determination that the activity is not being performed (e.g., terminated, paused) may be made at the same time the equipment is delinked from the worker or some predefined amount of time (e.g., 1 minute) after that.

According to one embodiment, after the delinking of the equipment and/or terminating/pausing of the activity, the activity tracking app may communicate with the worker 360. The communications may include, for example, asking the worker 360 to confirm the equipment is not being used (e.g., are you done with mower 3) and the activity is not being performed (e.g., are you finished mowing field 1) and/or asking the worker 360 questions about the equipment 300, 330 or activity. The delinking of the equipment from the worker 360 and/or the terminating/pausing of the activity may be recorded in the database 440. Information recorded may include, for example, worker, equipment, location, time, answers to questions, and images captured.

The activity tracking app may begin to receive beacon signals again and may determine the equipment associated with the beacons and assign that equipment to the worker 360. The assignment may be made, for example, after the beacon signals are received for a certain period of time (e.g., 30 seconds) and the activity tracking app may, for example, ask the worker 360 to confirm the assignment. The detection of the beacon signals and the assignment of equipment to the worker 360 may be recorded in the database 440.

If the equipment is assigned while the worker 360 is still in the area 700 an activity may be determined for the worker 360. If the equipment assigned is the same equipment 300, 330 that was previously assigned to the worker 360, the same activity may be initiated (e.g., mowing field 1). If new equipment is assigned to the worker 360, then a new activity may be initiated. For example, if the new equipment includes a baler instead of a mower the new task initiated may be baling field 1. The determination may be made, for example, after the equipment is assigned to the worker or a certain period of time (e.g., 30 seconds) after that and the activity tracking app may, for example, ask the worker 360 to confirm the activity. The determination of activity may be recorded in the database 440.

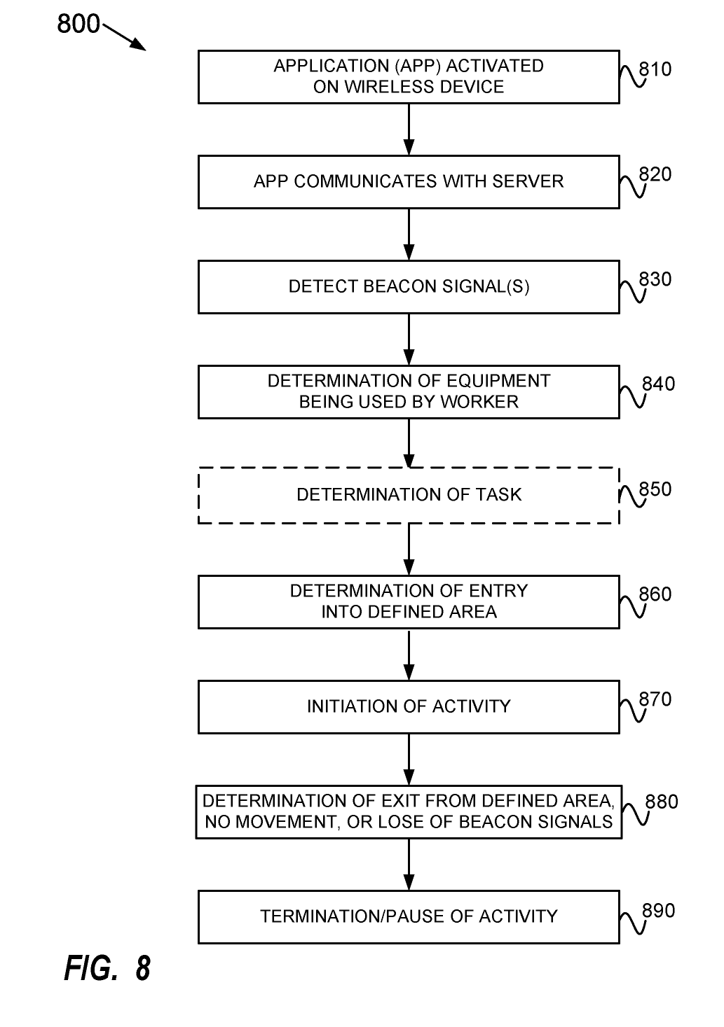

FIG. 8 illustrates a flow diagram of an example method 800 for utilizing an activity tracking app and an activity tracking system. Initially, the activity tracking app is activated on a workers wireless device 810. The activity tracking app communicates with a server for the activity tracking system 820. The communications may include, for example, recording location of the worker at defined intervals (e.g., every 15 minutes). The recording of the location information for a worker provides tracking of where the worker traveled during the course of their workday.

When in close proximity to equipment having beacons mounted thereto, the activity tracking app may receive the beacon signals (beacon identification) therefrom 830. The beacon identification may be documented and may be used to determine the equipment associated therewith and to assign this equipment to the worker 840. As previously noted, the assignment of the equipment may be made after the beacon signals have been received for a defined amount of time and the assignment may be confirmed by the worker. The assignment of the equipment to the worker may be documented. A task that is capable of being performed at this point may optionally be determined based on the combination of equipment assigned to the worker 850 (e.g., plowing based on tractor and plow being associated with worker). As previously noted, the determination of task need not be performed.

Location information gathered from the wireless device is utilized to determine when a worker enters a defined area that has the boundary defined by a geo-fence 860. As previously noted, the determination of entering the defined area may be made after the worker has been within the location for a defined amount of time and the determination of being with the defined area may be confirmed by the worker. The determination of entry into the defined area may be documented.

Activities may be initiated for the worker when it is determined that the appropriate parameters for the activity are in place 870. The appropriate parameters may include for example, assignment of equipment along with worker movement for initiation of a transportation activity (e.g., transporting tractor 1 and mower 2) and assignment of equipment (or determination of task) and being within a defined work area for initiation of a task activity (e.g., mowing field 1). As previously noted, the initiation of an activity may be made as soon as the worker begins to move the equipment or enters the defined area with the equipment or some defined amount of time thereafter. The initiation of the activity may be confirmed by the worker and may be documented.

After an activity is initiated, parameters may be detected that indicate changes to the activity 880. For example, a determination may be made that the worker has exited the defined area, that the worker is not moving, and/or that the beacon signal for the equipment is no longer being received. The determinations may be made as soon as an event occurs (e.g., worker crossed over boundary for defined area) or after the event has been in place for a defined amount of time (e.g., worker has remained outside the boundary for 30 seconds). The determination may be verified with the worker and may be recorded.

Based on these determinations, the activity may be paused or terminated 890. The pausing/termination may be done as soon as the determinations are made (e.g., worker exited the defined area) or after a defined amount of time. The pausing/terminating may be verified with the worker and may be recorded.

The method 800 is performed by the activity tracking app running on a wireless device 120 in conjunction with the activity tracking system running on the server 160. Computer-executable instructions stored on a computer-readable storage medium (e.g., memory 240) when executed by the processor 230 may cause the processor 230 to perform the method 800. The method 800 is in no way intended to be limited to the illustrated steps. Rather, additional steps can be added, steps can be combined, steps can be deleted, steps can be modified and/or the order of the steps can be modified without departing from the current scope.

The activity tracking system enables a worker 360 to track and document the activities they perform during the course of a day. The activity tracking system may also act as a workers timesheet and may automatically generate the timesheet based on all activities conducted by the worker during the course of the day. The activity tracking system allows for the capture of information specific to various activities (e.g., answers to questions, pictures). The activity tracking system enables an administrator to summarize and analyze what has occurred over time and extract different metrics. The administrator may run various reports related to the workers and/or activities that may be presented for example on an administrative dashboard or in printed copies. The metrics and/or the reports may be utilized to, for example, determine employee incentives, bonuses and accountability measurements. The metrics and/or the reports may also help identify areas of profitability and provide better inventory awareness.

The activity tracking system may enable an administrator to communicate with the worker during the course of the day. The communications may be, for example, checking status, asking questions, requesting information and/or providing work orders for specific assignments. The communications may be, for example, freeform messages. The specific assignments may include, for example, making a delivery to a customer, transferring equipment to another location, picking up supplies from a vendor, taking equipment in for servicing and/or performing grounds maintenance activities.

Some of the assignments may not involve equipment (and thus no beacon detection) or may involve equipment that by itself the system could not easily associate with a task or assignment (e.g., hard to determine what tasking may be being performed by a worker if they are only utilizing a pick-up truck). The various customer and vendor locations may be identified by a geo-fence so a determination can be made as to when the worker gets there and when they leave.

The administrator may request that the worker gather information related to the work orders they were assigned, including for example, photos of receipts, tickets, payments and/or other records. The administrator may send questions related to the work orders (e.g., was the customer happy with the delivery?, how long did they anticipate it would take to fix the tractor?). The information gathered and/or answers to the questions may be recorded for the work order.

It should be noted that in addition to activity tracking that the activity tracking system may also be utilized for tracking location of equipment. For example, the system records the location and time associated with when the wireless device 120 detects a beacon signal from the beacon located on equipment and the time and location when the beacon signal is lost. This data can be used to define where the equipment was moved from and to and can be utilized to determine last known location of equipment.

The wireless device 120 may be able to communicate with the on board diagnostics (OBD) of the equipment (e.g., tractors) via a wireless interface (e.g., Bluetooth, Wi-Fi). The activity tracking app may be able to gather certain information from the OBD (e.g., fuel levels) and record that data as part of the activity tracking. This information may be processed to determine, for example, amount of fuel used or fuel consumption rate for the activity. The activity tracking app may communicate with the OBD, for example, at the start and end of an activity.

The activity tracking system has been discussed as the server 160 having the configuration information (e.g., beacons identified, equipment associated with beacons, geo-fences defined for locations of interest, activities associated with equipment (or tasks) and locations of interest and communications with worker 360 associated with activities) stored therein. The mobile device 120 communicates location and beacons detected with the server 160 and the server 160 determines, for example, the equipment associated with the worker 360, when the worker 360 is within a location of interest, the activities being performed by the worker 360 and communications with the worker 360 associated with the activity). However, such an arrangement requires that the mobile device 120 and the server 160 are able to communicate via the data network 150 or via a wireless connection (e.g., Wi-Fi) to an access point (e.g., router) 130 for a provider network 140.

It is possible that the worker 360 may be working in an area where an Internet connection will not be available (e.g., no data network 150 availability, no Wi-Fi connection to a router 130 for a provider network 140 availability). According to one embodiment, some of the configuration information from the server 160 may be downloaded to the mobile device 120. The downloading of information to the wireless device 120 may be limited to information that the worker 360 is likely to need (e.g., beacon information for only the beacons located on equipment the worker 360 is likely to encounter, geo-maps for only the locations the worker 360 is likely to encounter, only activities associated with the likely to be encountered beacons/equipment and locations). Such an embodiment would enable the activity tracking app running on the mobile device 120 to, for example, confirm a beacon detected is associated with the system, determine the equipment associated with the beacon, assign the equipment to the worker 360, determine when the worker 360 is with a location of interest and/or determine activities being performed by the worker 360. It should be noted that in addition to the configuration information that the activity tracking app would require some additional instructions to, for example, process the configuration information.

Alternatively, in cases where an Internet connection is not available the activity tracking app may simply record information (e.g., beacons detected, location information, time) until the Internet connection is available. Once the Internet connection is available, the activity tracking app running on the wireless device 120 may communicate with the server 160 in order to determine what may have occurred (e.g., equipment associated with workers, locations of interest entered/exited, activities performed). The activity tracking app may inform the worker that no Internet connection is available and prompt them to record any information associated with an activity they may be performing (e.g., type of seed used, height of mower).

It should be noted that the activity tracking system has been described with respect to farming but is in no way intended to be limited thereto. Rather, the system can be utilized for any number of industries without departing from the current scope. Any industry that can utilize a wireless device to track location of workers and detect beacon signals on equipment that the workers may utilize can use the system. The use of geo-fences around defined areas further enhances the operation of the system. By way of example, the system could be utilized to track the activities of loggers that utilize different machines to cut down and transport trees and the locations where the trees are being cut and transported from/to. The system could be also be utilized by, for example, coal mines, quarries, plants, trucking companies and the like.

The system could even be used by entities that perform work on different products (e.g., service stations). When a car is dropped off at a shop it may have a beacon placed thereon and the beacon may be identified with the car. The shop may have geo-fences around the various bays that may perform different tasks (e.g., oil change, brakes/tires, inspection, engine work, body work, clean-up). The workers may have wireless devices that can detect the beacon signals and the locations of the worker. The system may determine what location the worker is in and the car that they are working on (in close proximity to) and determine the activities based thereon (e.g., oil change for Bob Smith's Toyota, work on brakes on John Jones' Pontiac).

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for tracking activities of a worker, the method comprising
detecting signals from beacons attached to equipment when a worker is in close proximity to the equipment, wherein the signals include an identification for an associated beacon;
determining the equipment being utilized by the worker based on the beacon identification;
determining location of the worker based on GPS coordinates; and
determining an activity is being performed by the worker based on the determination of the equipment being utilized by the worker and the determination of the location of the worker.

2. The method of claim 1, further comprising recording initiation of the activity for the worker.

3. The method of claim 1, further comprising defining geo-fences around areas of interest.

4. The method of claim 3, wherein the areas of interest include at least one of fields, lots, barns, stores, garages, warehouses, vendors, suppliers and customers.

5. The method of claim 3, further comprising determining if the worker is within a defined area of interest by comparing the location of the worker to the geo-fence defined for the area of interest.

6. The method of claim 5, wherein the determining the activity is being performed includes determining the activity is being performed based on the determination of the equipment being utilized by the worker and the determination of the worker being with the defined area of interest.

7. The method of claim 1, further comprising communicating with the worker to confirm the equipment.

8. The method of claim 1, further comprising communicating with the worker to confirm the activity.

9. The method of claim 1, further comprising gathering information from the worker about the activity.

10. The method of claim 9, wherein the information includes pictures.

11. The method of claim 1, further comprising recording the workers location at defined intervals.

12. The method of claim 1, further comprising associating the equipment a beacon is located on with the identification for the beacon.

13. A system for tracking activities of a worker, the system comprising
beacons capable of transmitting identification signals a short distance, wherein the beacons are located on equipment;
a wireless device configured to receive the identification signals when in close proximity to the equipment the beacon is located on, determine location of a worker carrying the wireless device, provide wireless communications, and interface with the worker; and
a server configured to define the beacons associated with the system and the equipment the beacon is located on, define geo-fences for areas of interest, associate activities with a combination of equipment and areas of interest, communicate with the wireless device and record information gathered from the wireless device.

14. The system of claim 13, wherein the wireless device and the server communicate in order to determine the equipment being utilized by the worker based on the beacon identification detected by the wireless device.

15. The system of claim 14, wherein the wireless device and the server communicate in order to determine an activity being performed by the worker based on the determination of the equipment being utilized by the worker and the location of the worker.

16. The system of claim 14, wherein the wireless device and the server communicate in order determine when the worker is within a defined area of interest by comparing the location of the worker to the geo-fence defined for the area of interest.

17. The system of claim 16, wherein the wireless device and the server communicate in order determine an activity being performed by the worker based on the determination of the equipment being utilized by the worker and the determination of the worker being with the defined area of interest.

18. The system of claim 13, wherein the server can provide specific work orders to the wireless device.

19. A non-transient computer readable medium storing instructions that when executed by a processor cause the processor to:
detect signals from beacons attached to equipment when a worker is in close proximity to the equipment, wherein the signals include an identification for an associated beacon;
determine the equipment being utilized by the worker based on the beacon identification;
determine location of the worker based on GPS coordinates;
determine if the worker is within a defined area of interest by comparing the location of the worker to geo-fences for defined areas of interest; and
determine an activity is being performed by the worker based on the determination of the equipment being utilized by the worker and the determination of the worker being with the defined area of interest.

20. The non-transient computer readable medium of claim 19, wherein when executed the instructions further cause the processor to communicate with the worker, wherein the communications includes at least some subset of confirming the equipment being utilized by the worker, confirming the activity being performed by the worker, and gathering information from the worker about the activity.
